(19) United States
(12) Patent Application Publication
(10) Pub. No.: US 2005/0121832 A1
(43) Pub. Date: Jun. 9, 2005

(54) Process for the treatment of cellulosic moulded bodies

(76) Inventors: Christian Rohrer, Linz (AT); Werner Richardt, St. Georgen (AT); Evelyn Schobesberger, Regau (AT); Gerhard Reiter, Seewalchen (AT)

Correspondence Address: BAKER & BOTTS, 30 ROCKEFELLER PLAZA, NEW YORK, NY, 10112, US

(21) Appl. No.: 10/869,576

(22) Filed: Jun. 16, 2004

Related U.S. Application Data
(63) Continuation of application No. PCT/AT02/00362, filed on Dec. 19, 2002.

(30) Foreign Application Priority Data
Dec. 20, 2001 (AT) A2012/2001

(51) Int. Cl. H05B 6/00

(52) U.S. Cl. 264/430

(57) ABSTRACT

The invention relates to a process for the treatment of cellulosic moulded bodies produced from a solution of cellulose in an aqueous tertiary amine oxide, in particular fibres, wherein the moulded bodies are contacted with a textile auxiliary agent. The process according to the invention is characterized in that the textile auxiliary agent comprises a cyclodextrin and/or a cyclodextrin derivative.

The invention relates to a process for the treatment of cellulosic moulded bodies produced from a solution of cellulose in an aqueous tertiary amine oxide, in particular fibres and assemblies containing those fibres, in which process the moulded bodies are contacted with a textile auxiliary agent in order to impart improved properties to the moulded bodies.

For the purpose of the present invention, the term “moulded body” in particular also comprises sponges.

As an alternative to the viscose process, in recent years there have been described a number of processes wherein cellulose, without forming a derivative, is dissolved in an organic solvent, a combination of an organic solvent and an inorganic salt, or in an aqueous saline solution. Cellulose fibres made from such solutions are called “solvent-spun fibres” and have received by BISFA (The International Bureau for the Standardisation of man made Fibres) the generic name Lyocell. As Lyocell, BISFA defines a cellulose fibre obtained by a spinning process from an organic solvent. By “organic solvent”, BISFA understands a mixture of an organic chemical and water. “Solvent-spinning” is supposed to mean dissolution and spinning without derivatization.

So far, however, only a single process for the production of a solvent-spun cellulose fibre has achieved industrial-scale realization. In this process a tertiary amine-oxide, in particular N-methylmorpholine-N-oxide (NMMO), is used as a solvent. Such a process is described for instance in U.S. Pat. No. 4,246,221 and provides fibres which are distinguished by a high tenacity, a high wet-modulus and a high loop strength.

WO 99/19555 describes a process for the treatment of solvent-spun fibres wherein the fibres are contacted with 2,4-dichloro-6-hydroxy-1.3.5-triazine or with a salt thereof, respectively. The fibres thus produced are distinguished by a better resistance to fibrillation.

From U.S. Pat. No. 5,728,823, cyclodextrin derivatives, among others, the sodium salt of 2-chloro-4-hydroxy-1.3.5-triazinyl-cyclodextrin, are known. U.S. Pat. No. 5,728,823, furthermore describes membranes, films, textiles or leather to which a cyclodextrin derivative is bound. Textiles treated with cyclodextrin derivatives are suitable, for instance, for the absorption of unpleasant smells.

WO 01/48025 describes cyclodextrins which are covalently bound to a polysaccharide by means of a cross-linking agent.

It now was found that cellulosic moulded bodies produced from a solution of cellulose in an aqueous tertiary amine oxide may be treated with a textile auxiliary agent comprising a cyclodextrin and/or a cyclodextrin derivative, thereby creating products having improved properties.

Preferably, the moulded bodies are fibres in the never-dried state. The fibres may be treated in the never-dried state in an after treatment stage of a continuously operating production plant.

It is known that cyclodextrins can include agents which then may be released, for example, over a longer period of time. In the process according to the invention, it is possible to charge the fibre treated with a cyclodextrin or a cyclodextrin derivative, respectively, in the course of the continuous production process with such an agent simultaneously and/or subsequently.

The treatment with the textile auxiliary agent preferably is effected in an alkaline environment.

Also preferably, the textile auxiliary agent additionally comprises a cross-linking agent. Particularly preferably, 2,4-dichloro-6-hydroxy-1.3.5-triazine or a salt thereof, respectively, is used as the cross-linking agent.

In the state of the art according to U.S. Pat. No. 5,728,823, at first a cyclodextrin derivative, e.g. the sodium salt of 2-chloro-4-hydroxy-1.3.5-triazinyl-cyclodextrin, must be produced under great efforts in order to apply said derivative subsequently onto the material to be treated.

It now was shown that the cyclodextrin and a cross-linking agent, in particular the 2,4-dichloro-6-hydroxy-1.3.5-triazine, may be added to the fibres to be treated without first having to prepare a compound of those two substances, whereby good results are achieved.

In a further embodiment of the process according to the invention, the textile auxiliary agent comprises 2-chloro-4-hydroxy-1.3.5-triazinyl-cyclodextrin (MCT-CD) or a salt thereof, respectively.

The invention also relates to a solvent-spun, cellulosic fibre obtainable according to the process of the invention as well as to fibre assemblies containing those fibres.

### EXAMPLE 1

Solvent-spun fibres produced according to the process described in WO 93/19230 and having a titre of 1.3 dtex were treated in the never-dried state as follows:

At a liquor ratio of 1:10, the fibres were impregnated with a solution, containing 20 g/l of sodium salt of 2,4-dichloro-6-hydroxy-1.3.5-triazine, 16 g/l of NaOH and 100 g/l of a cyclodextrin (CAVAMAX W7, manufacturer Messrs. Wacker-Chemie), for 5 minutes at room temperature. Thereupon, the fibres were squeezed to a moisture content of 100%-110% by means of a squeezer and were heat-treated with saturated steam (100%) at 100° C. for 5 minutes, were washed out and dried.

The content of active cyclodextrin in the fibres thus produced was photometrically evaluated by way of the decolourization of a phenolphthalein solution (552 nm) and amounted to 2.33% by weight.

The degree of fibrillation of the fibres was determined by way of the wet abrasion resistance (testing method in accordance with WO 99/19555) of the individual fibres. According to this testing method, the sample treated according to the invention turns out to exhibit an average value of 210 revolutions. Compared with that, an untreated fibre exhibits a wet abrasion value of only 40-60 revolutions.

### EXAMPLE 2

The same procedure as in Example 1 was followed, with the treatment solution containing 20 g/l of sodium salt of 2,4-dichloro-6-hydroxy-1.3.5-triazine, 16 g/l of NaOH, 30 g/l of soda and 50 g/l of a cyclodextrin (CAVAMAX W7, manufacturer Messrs. Wacker-Chemie).

The content of active cyclodextrin in the fibres thus obtained amounted to 1.65% by weight, the wet abrasion value was at 470 revolutions.

### EXAMPLE 3

The same procedure as in Example 1 was followed, with the treatment solution containing 30 g/l of soda and 100 g/l of 2-chloro-4-hydroxy-1.3.5-triazinyl-cyclodextrin (MCT-CD; CAVASOL W7 MCT, manufacturer Messrs. Wacker-Chemie).

The content of active MCT-CD in the fibres thus obtained amounted to 1.89% by weight.

1-7. (canceled)

8. A process for the treatment of a cellulosic molded body comprising contacting a cellulosic molded body produced from a solution of cellulose in the presence of an aqueous tertiary amine oxide with a textile auxiliary agent comprising a compound selected from the group consisting of a cyclodextrin and a cyclodextrin derivative.

9. The process according to claim 8, wherein the cellulosic molded body is a fiber.

10. The process according to claim 9, wherein the fiber is in a never-dried state.

11. The process according to claim 8, wherein the textile auxiliary agent further comprises a cross-linking agent.

12. The process according to claim 9, wherein the textile auxiliary agent further comprises a cross-linking agent.

13. The process according to claim 10, wherein the textile auxiliary agent further comprises a cross-linking agent.

14. The process according to claim 11, wherein the cross-linking agent is selected from the group consisting of 2,4-dichloro-6-hydroxy-1,3,5-triazine and a salt thereof.

15. The process according to claim 12, wherein the cross-linking agent is selected from the group consisting of 2,4-dichloro-6-hydroxy-1,3,5-triazine and a salt thereof.

16. The process according to claim 13, wherein the cross-linking agent is selected from the group consisting of 2,4-dichloro-6-hydroxy-1,3,5-triazine and a salt thereof.

17. The process according to claim 8, wherein the textile auxiliary agent comprises a compound selected from the group consisting of 2-chloro-4-hydroxy-1,3,5-triazinyl-cyclodextrin and a salt thereof.

18. The process according to claim 9, wherein the textile auxiliary agent comprises a compound selected from the group consisting of 2-chloro-4-hydroxy-1,3,5-triazinyl-cyclodextrin and a salt thereof.

19. The process according to claim 10, wherein the textile auxiliary agent comprises a compound selected from the group consisting of 2-chloro-4-hydroxy-1,3,5-triazinyl-cyclodextrin and a salt thereof.

20. A cellulosic molded body prepared by a method comprising the step of contacting a cellulosic molded body produced from a solution of cellulose in the presence of an aqueous tertiary amine oxide with a textile auxiliary agent comprising a compound selected from the group consisting of a cyclodextrin and a cyclodextrin derivative.

21. The cellulosic molded body according to claim 20, which is a fiber.

22. The cellulosic molded body according to claim 20, wherein the textile auxiliary agent further comprises a cross-linking agent.

23. The cellulosic molded body according to claim 21, wherein the textile auxiliary agent further comprises a cross-linking agent.

24. The cellulosic molded body according to claim 22, wherein the cross-linking agent is selected from the group consisting of 2,4-dichloro-6-hydroxy-1,3,5-triazine and a salt thereof.

25. The cellulosic molded body according to claim 23, wherein the cross-linking agent is selected from the group consisting of 2,4-dichloro-6-hydroxy-1,3,5-triazine and a salt thereof.

26. The cellulosic molded body according to claim 20, wherein the textile auxiliary agent comprises a compound selected from the group consisting of 2-chloro-4-hydroxy-1,3,5-triazinyl-cyclodextrin and a salt thereof.

27. The cellulosic molded body of claim 21, wherein the textile auxiliary agent comprises a compound selected selected from the group consisting of 2-chloro-4-hydroxy-1,3,5-triazinyl-cyclodextrin and a salt thereof.

28. A fiber assembly comprising a fiber produced according to the process of claim 9.

29. A fiber assembly comprising a fiber according to claim 21.
